(19) United States
(12) Patent Application Publication
(10) Pub. No.: US 2014/0149528 A1
(43) Pub. Date: May 29, 2014

(54) MPI COMMUNICATION OF GPU BUFFERS

(71) Applicants: Rolf VandaVaart, Harvard, CA (US); Timothy James Murray, San Francisco, CA (US); Peter Michael Buckingham, San Jose, CA (US)

(72) Inventors: Rolf VandaVaart, Harvard, CA (US); Timothy James Murray, San Francisco, CA (US); Peter Michael Buckingham, San Jose, CA (US)

(73) Assignee: NVIDIA CORPORATION, Santa Clara, CA (US)

(21) Appl. No.: 13/689,509

(22) Filed: Nov. 29, 2012

(51) Int. Cl. H04L 29/08

(52) U.S. Cl. CPC H04L 29/08072
USPC 709/213

(57) ABSTRACT

A technique for enhancing the efficiency and speed of data transmission within and across multiple, separate computer systems includes the use of an MPI library/engine. The MPI library/engine is configured to facilitate the transfer of data directly from one location to another location within the same computer system and/or on separate computer systems via a network connection. Data stored in one GPU buffer may be transferred directly to another GPU buffer without having to move the data into and out of system memory or other intermediate send and receive buffers.

### BACKGROUND OF THE INVENTION

1. Field of the Invention

Embodiments of the invention relate to communication systems and software for enhancing the efficiency and speed of data transmission within and across one or more computer systems.

2. Description of the Related Art

Conventional communications software allows a user to run programs across multiple, separate computer systems and/or across multiple processors within the same computer system. One feature of this software is the ability to send and receive data between processes running on separate computer systems and/or processors. Send and receive buffers located in host memory are required for transmitting the data between the processes. The communications software causes data to be transmitted from the send buffer to the receive buffer.

In operation, when sending data that resides in a location other than the host memory, such as in a graphics processing unit memory, the data has to be moved explicitly into a send buffer located in host memory (or located at some other intermediate location) before that data can be sent to another computer system or processor. In the receiving computer system or processor, the data has to be received into a receive buffer located in host memory (or located at some other intermediate location) and then moved explicitly into a destination location outside of the host memory, such as another graphics processing unit memory.

One drawback to this approach is the requirement to move data back and forth between send/receive buffers. In particular, it is a burden for programmers, to transmit data, to explicitly move the data from a source location outside of host memory to the send buffer; and to receive data, to explicitly move the data from the receive buffer to a destination location outside of host memory.

Accordingly, what is needed in the art is a more effective technique for transmitting data within and across multiple, separate computer systems.

### SUMMARY OF THE INVENTION

Embodiments of the invention include method for transmitting data between graphics processing unit (GPU) buffers, the method comprising receiving a handle from a send message passing interface (MPI) engine that resides in a first machine; calling into a software stack with the handle, wherein the software stack resides in the first machine; receiving an address of a send GPU buffer from the software stack, wherein the send GPU buffer resides in the first machine; and issuing a command for a memory access operation to retrieve data from the send GPU buffer.

Embodiments of the invention include a non-transitory computer readable storage medium comprising instructions for transmitting data between graphics processing unit (GPU) buffers that, when executed by a message passing interface (MPI) engine, cause the MPI engine to carry out the steps of receiving a handle from a send message passing interface MPI engine that resides in a first machine; calling into a software stack with the handle, wherein the software stack resides in the first machine; receiving an address of a send GPU buffer from the software stack, wherein the send GPU buffer resides in the first machine; and issuing a command for a memory access operation to retrieve data from the send GPU buffer.

Embodiments of the invention include a system for transmitting data between graphics processing unit (GPU) buffers, the system comprising a receive GPU buffer that resides in a first machine; and a receive message passing interface (MPI) engine that resides in the first machine, the receive MPI engine configured to perform the steps of receiving a handle from a send message passing interface (MPI) engine that resides in a first machine; calling into a software stack with the handle, wherein the software stack resides in the first machine; receiving an address of a send GPU buffer from the software stack, wherein the send GPU buffer resides in the first machine; and issuing a command for a memory access operation to retrieve data from the send GPU buffer.

An advantage of the embodiments of the invention is more direct and efficient data transfer technique that eliminates the requirement for a user (e.g., a programmer) to move data to system memory and/or another intermediate buffer before moving the data from an initial location to a desired location.

### BRIEF DESCRIPTION OF THE DRAWINGS

So that the manner in which the above recited features of the embodiments of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a network system configured to implement one or more aspects of the present invention.

FIG. 2 is a flow diagram of method steps for transmitting data between two computer systems via a network connection, according to one embodiment of the present invention.

FIG. 3 is a block diagram of a computer system having two graphics processing units and configured to implement one or more aspects of the present invention.

FIG. 4 is a flow diagram of method steps for transmitting data between two graphics processing units within the same computer system, according to one embodiment of the present invention.

### DETAILED DESCRIPTION

In the following description, numerous specific details are set forth to provide a more thorough understanding of the embodiments of the invention. However, it will be apparent to one of skill in the art that the embodiments of the invention may be practiced without one or more of these specific details.

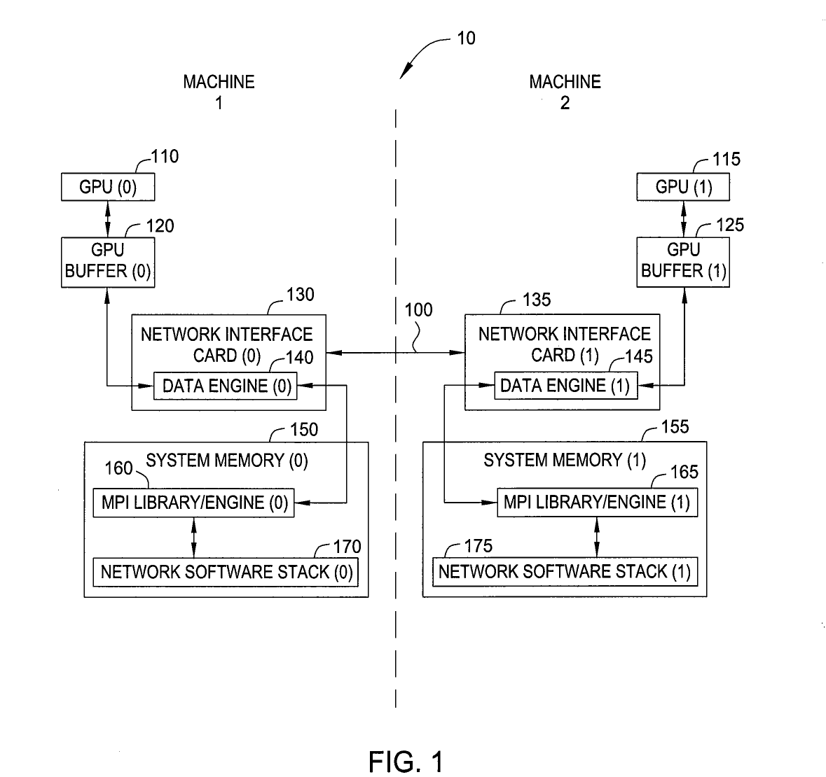

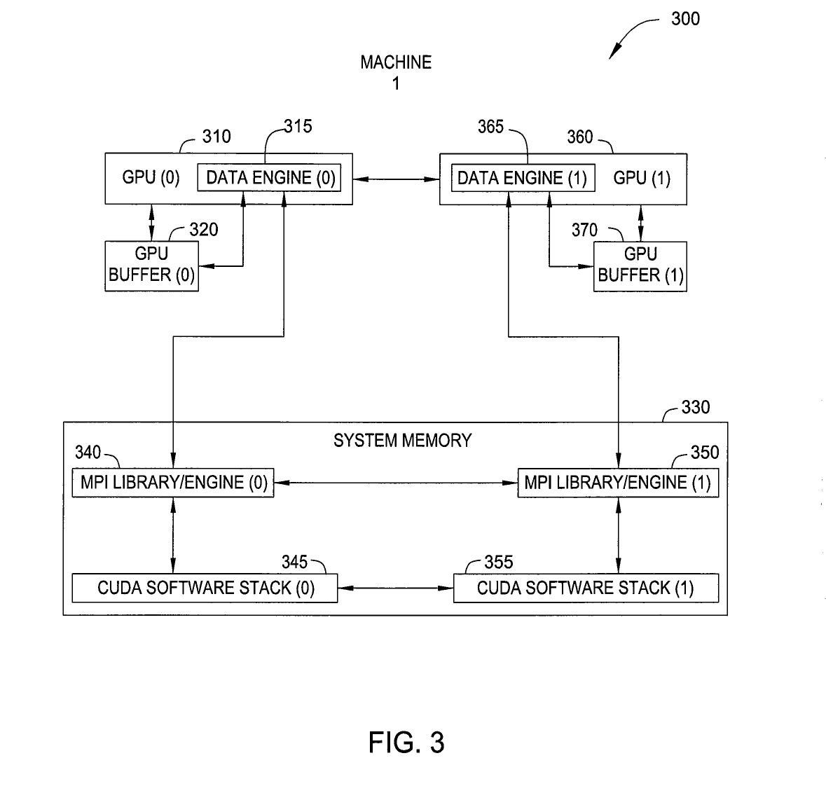

FIGS. 1 and 3 are block diagram illustrating a network system 10 that includes two different computer systems and a computer system 300, respectively. Both the network system 10 and the computer system 300 are configured to implement one or more embodiments of the invention. In FIG. 1, the network system 10 includes a first computer system, identified as Machine 1, and a second computer system, identified as Machine 2, that are able to communicate with each other via a network connection 100. In FIG. 3, the computer system 300, identified as Machine 1, may be the same as or different than Machine 1 and/or Machine 2 illustrated in FIG. 1.

The computer systems of the network system 10 and the computer system 300 illustrated in FIGS. 1 and 3, respectively, may be operable with communication software to allow users, such as programmers, to run multiple processes of a program across multiple graphics processing units (“GPU”s) on the same and/or a different computer system. The communication software may include a standardized and/or portable message passing (data passing) protocol, referred to herein as a message passing interface (”MPI”) as known in the art. The MPI interface provides essential virtual topology, synchronization, and communication functionality between a set of processes running on one or more computer systems and/or processing units within a computer system using independent programmable language functions that are stored in an MPI library or MPI engine. The MPI library/engine may include and may be operable to execute a plurality of standard, defined core functions that are useful to a wide range of users writing portable message passing programs as known in the art. The MPI library/engine may be stored in system memory of each computer system.

In one embodiment, the MPI interface enables a user to send a request/command to the MPI library/engine to obtain and move data from one location (e.g. GPU memory buffer) in one computer system to another location (e.g. GPU memory buffer) on the same or a different computer system. The data request may include one or more pointers and/or one or more addresses, as known in the art, to identify the locations where the data is to be retrieved and sent. The pointer may be a data value that refers to another data value stored in a particular location, such as a specific GPU buffer. The addresses may be the location where the stored data value is located and/or where the stored data value should be sent. Other data request features known in the art may be used to transmit data using the embodiments of the invention.

In one embodiment, the GPUs identified in FIGS. 1 and 3 may incorporate circuitry optimized for graphics and video processing, and may be graphics and video subsystems that deliver pixels to one or more display devices. The GPUs may include graphics processors (data engines) with rendering pipelines that can be configured to perform various operations related to generating pixel data from graphics data supplied by system memory. The GPUs may be identical or different, and may each have dedicated memory devices or no dedicated memory devices. GPU buffers may be used as graphics memory to store and update pixel data for delivering to one or more display devices. The GPUs may transfer data from system memory into other memory, such as GPU buffers, process the data, and write result data back to system memory, where such data can be accessed by other computer system components.

In one embodiment, the GPUs identified in FIGS. 1 and 3 may be configured for general purpose computations, and may incorporate circuitry optimized for general purpose processing, while preserving the underlying computational architecture described herein. The GPUs may advantageously implement a highly parallel processing architecture. Each GPU may include one or more general processing clusters having data engines capable of executing a large number of threads concurrently, where each thread is an instance of a program. In various applications, different general processing clusters may be allocated for processing different types of programs and/or for performing different types of computations. The allocation of general processing clusters may vary dependent on the workload arising for each type of program or computation.

In one embodiment, the GPUs identified in FIGS. 1 and 3 may be operable using a Compute Unified Device Architecture (CUDA) as known in the art, which is a parallel computing platform and programming model developed by NVIDIA Corporation. The CUDA platform (also referred to herein as a software stack) provides users with access to one or more sets of instructions for communicating with the GPUs and the GPUs memory. The CUDA platform is accessible to users, such as programmers or developers, via industry standard programming languages such as C, C++, and Fortran as known in the art.

Referring now to FIG. 1, Machine 1 includes, without limitation, a GPU (0) 110, a GPU buffer (0) 120, a network interface card (0) 130, and a system memory (0) 150. The network interface card (0) 130 has a data engine (0) 140. The system memory (0) 150 has an MPI library/engine (0) 160 and a network software stack (0) 170. Similarly, Machine 2 includes, without limitation, a GPU (1) 115, a GPU buffer (1) 125, a network interface card (1) 135, and a system memory (1) 155. The network interface card (1) 135 has a data engine (1) 145. The system memory (1) 155 has an MPI library/engine (1) 165 and a network software stack (1) 175. Machine 1 and Machine 2 may include any number and/or arrangement of the components illustrated in FIG. 1.

The network interface card (0) 130 and the network interface card (1) 135 communicate with one another via the network connection 100, as known in the art. The data engine (0) 140 and the data engine (1) 145 included within the network interface card (0) 130 and the network interface card (1) 135, respectively, handle and/or process data that is transmitted across the network connection 100. The network connection 100 may include any form of data transmission link, bus, and/or protocol known in the art. The network connection 100 may include, but is not limited to, InfiniBand, Fibre Channel, Peripheral Component Interconnect Express, Serial ATA, and Universal Serial Bus as known in the art. The network software stack (0) 170 and the network software stack (1) 175 are stored in the system memory (0) 150 and the system memory (1) 155, respectively, of each computer system and include one or more sets of instructions for communicating with the network interface card (0) 130 and the network interface card (1) 135.

Referring to FIG. 3, Machine 1 includes, without limitation, a GPU (0) 310, a GPU buffer (0) 320, a GPU (1) 360, a GPU buffer (1) 370, and a system memory 330. A data engine (0) 315 and a data engine (1) 365 are provided within the GPU (0) 310 and the GPU (1) 360, respectively, for processing one or more batches of data. The MPI library/engine (0) 340 and the MPI library/engine (1) 350 are stored in the system memory 330. A CUDA software stack (0) 345 and a CUDA software stack (1) 355 are also stored in the system memory 330. Machine 1 may include any number and/or arrangement of the components illustrated in FIG. 3.

Although only one or two computers systems, GPUs, GPU buffers, data engines, network interface cards, library/engines, software stacks, and/or system memory are shown in FIGS. 1 and 3, embodiments of the invention may be used with a plurality of these components, each of which may be in communication with each other via one or more networks as known in the art.

Persons of ordinary skill in the art will understand that the architectures described in FIGS. 1 and 3 in no way limit the scope of the invention and that the techniques taught herein may be implemented on any properly configured processing unit, computer system, and/or network connection without departing the scope of the invention.

### MPI Communication of GPU Buffers via Network

As illustrated in FIG. 1, Machine 1 and Machine 2 are configured to transmit data directly from the GPU buffer (0) 120 to the GPU buffer (1) 125 without having to create and/or move the data into and from any intermediate memory buffers. In particular, the MPI library/engine (0) 160 and the MPI library/engine (1) 165 are configured to communicate with the network software stack (0) 170 and the network software stack (1) 175, respectively, to facilitate the direct transmission of data from the GPU buffer (0) 120 to the GPU buffer (1) 125 via the network connection 100. In particular still, the MPI library/engine (0) 160 and the MPI library/engine (1) 165 communicate with the network software stack (0) 170 and the network software stack (1) 175, respectively, to instruct the data engine (0) 140 and the data engine (1) 145 of the network interface cards to send and receive data directly to and from the GPU buffer (0) 120 and the GPU buffer (1) 125 via the network connection 100.

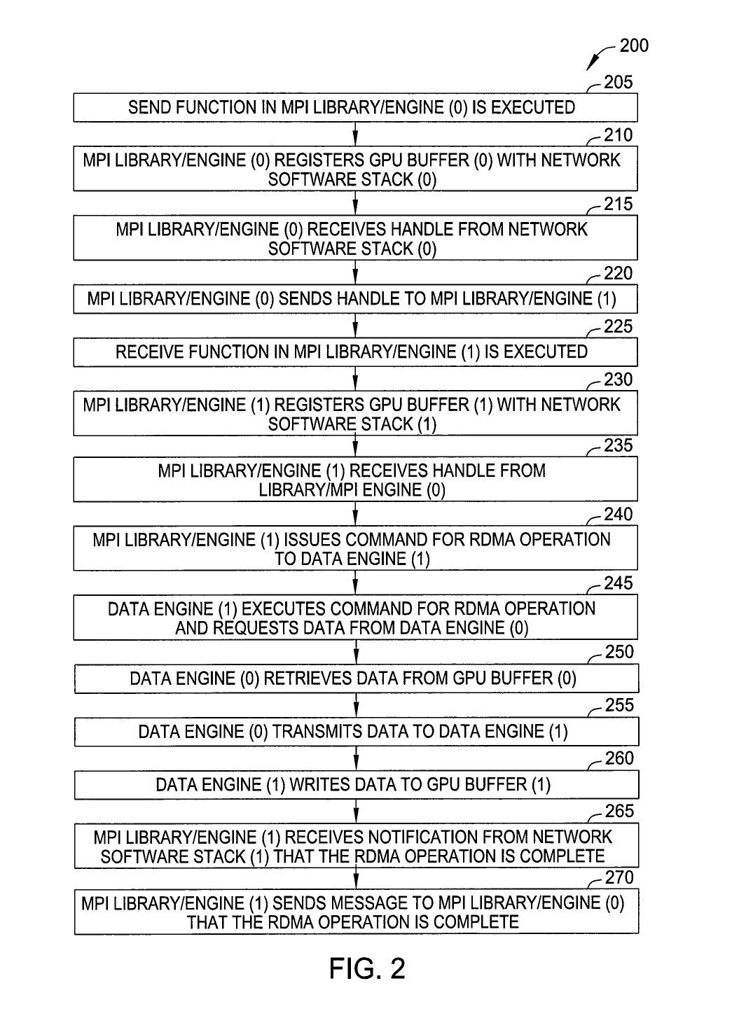

FIG. 2 is a flow diagram of method steps for transmitting data between two computer systems via a network connection, according to one embodiment of the present invention. Although the method steps are described in conjunction with the systems of FIG. 1, persons of ordinary skill in the art will understand that any computer system or network of computer systems configured to perform the method steps, in any order, is within the scope of the embodiments of the invention.

As shown, a method 200 begins at step 205, where the MPI library/engine (0) executes a send function that is stored in the MPI library/engine (0). As persons skilled in the art will understand, the send function may be an API call/function executed as part of or in response to a data transmission operation received from a software application. At step 210, the MPI library/engine (0) registers the GPU buffer (0) with the network software stack (0). In response, at step 215, the MPI library/engine (0) receives a handle from the network software stack (0). At step 220, the MPI library/engine (0) sends the handle to the MPI library/engine (1) within Machine 2 via the network connection 100.

In one embodiment, the handle may include the address of the GPU buffer (0) and/or information related to transmitting data across the network connection 100. In alternative embodiments, the handle may not include the address of the GPU buffer (0). In such cases, the address of the GPU buffer (0) may be transmitted across the network connection 100 by the MPI library/engine (0) separate from the handle.

At step 225, the MPI library/engine (1) executes a receive function that is stored in the MPI library/engine (1). As persons skilled in the art will understand, the receive function may be an API call/function executed as part of or in response to a data transmission operation received from a software application. At step 230, the MPI library/engine (1) registers the GPU buffer (1) with network software stack (1). At step 235, the MPI library/engine (1) receives the handle from the MPI library/engine (0).

Upon receiving the handle, the MPI library/engine (1), at step 240, issues a command for a remote direct memory access (RDMA) operation to the data engine (1). At step 245, the data engine (1) executes the command for RDMA operation and requests the data stored in the GPU buffer (0) from the data engine (0). At step 250, the data engine (0) retrieves the data stored in the GPU buffer (0). At step 255, the data engine (0) transmits the data to the data engine (1) across the network connection 100. At step 260, the data engine (1) writes the data to the GPU buffer (1) where the data is stored.

After the data is copied to the GPU buffer (1), at step 265, the MPI library/engine (1) receives a notification from the network software stack (1) that the RDMA operation is complete. At step 270, the MPI library/engine (1) sends a message to the MPI library/engine (0) that the RDMA operation is complete.

In sum, the method steps may be repeated any number of times for any number of data transmission operations between one or more computer systems across one or more network connections. These direct data transfers eliminates the need for a user (e.g., a programmer) to move data to system memory and/or another intermediate buffer before moving the data from an initial location to a desired location. The MPI libraries/engines are configured to carry out automatically such data transmission operations, thereby alleviating much of the work that had to be done by users/programmers in prior art approaches.

### MPI Communication of GPU Buffers Within Computer System

As illustrated in FIG. 3, Machine 1 is configured to transmit data directly from the GPU buffer (0) 320 to the GPU buffer (1) 370 without having to create and/or move the data into and from any intermediate memory buffers. In particular, the MPI library/engine (0) 360 and the MPI library/engine (1) 350 are configured to communicate with the CUDA software stack (0) 345 and the CUDA software stack (1) 355, respectively, to facilitate the direct transmission of data from the GPU buffer (0) 320 to the GPU buffer (1) 370. In particular still, the MPI library/engine (0) 340 and the MPI library/engine (1) 350 communicate with the CUDA software stack (0) 345 and the CUDA software stack (1) 355, respectively, to instruct the data engine (0) 315 and the data engine (1) 365 of the GPUs to send and receive data directly to and from the GPU buffer (0) 320 and the GPU buffer (1) 370.

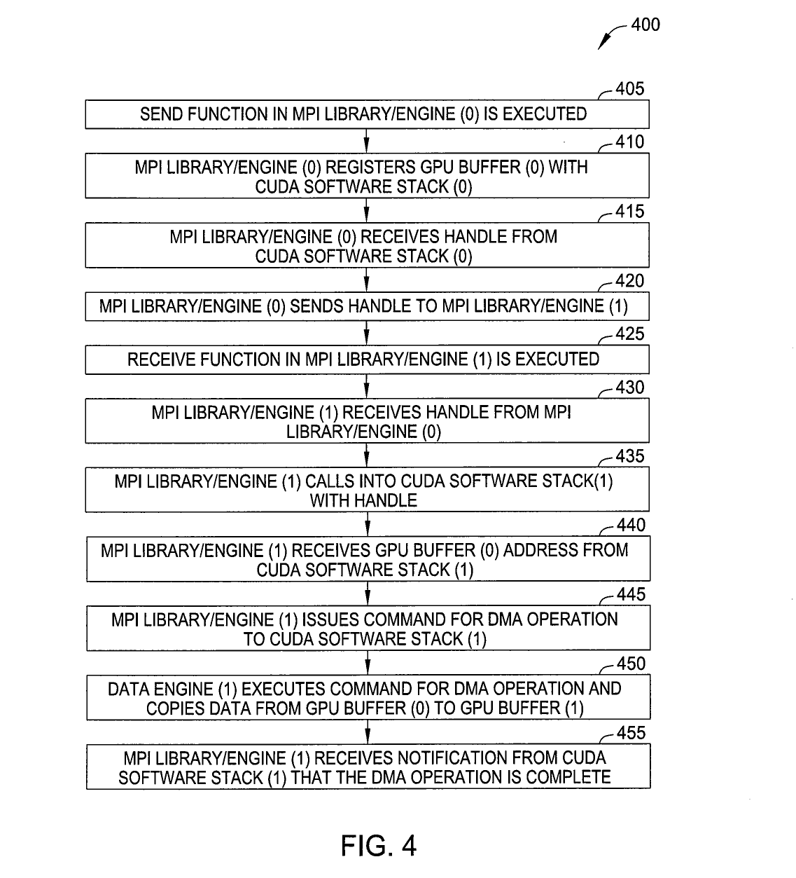

FIG. 4 is a flow diagram of method steps for transmitting data between two graphics processing units within the same computer system, according to one embodiment of the present invention. Although the method steps are described in conjunction with the system of FIG. 3, persons of ordinary skill in the art will understand that any computer system configured to perform the method steps, in any order, is within the scope of the embodiments of the invention.

As shown, a method 400 begins at step 405, where the MPI library/engine (0) executes a send function that is stored in the MPI library/engine (0). As persons skilled in the art will understand, the send function may be an API call/function executed as part of or in response to a data transmission operation received from a software application. At step 410, in response to the send function, the MPI library/engine (0) registers the GPU buffer (0) with the CUDA software stack (0). In response to the registration, at step 415, the MPI library/engine (0) receives a handle from the CUDA software stack (0). At step 420, the MPI library/engine (0) then sends the handle to MPI library/engine (1).

In one embodiment, the handle may include the address of the GPU buffer (0) and/or information related to transmitting data across GPU buffers. In alternative embodiments, the handle may not include the address of the GPU buffer (0). In such cases, the address of the GPU buffer (0) may be transmitted by the MPI library/engine (0) separate from the handle.

At step 425, the MPI library engine (1) executes a receive function that is stored in the MPI library/engine (1). As persons skilled in the art will understand, the receive function may be an API call/function executed as part of or in response to a data transmission operation received from a software application. At step 430, the MPI library/engine (1) then receives the handle from the MPI library/engine (0). At step 435, the MPI library/engine (1) calls into the CUDA software stack (1) and hands the handle to the CUDA software stack (1) in order to obtain the address of the GPU buffer (0). At step 440, the MPI library/engine (1) receives the GPU buffer (0) address from the CUDA software stack (1).

At step 445, upon receiving the GPU (0) address, the MPI library/engine (1) issues a command for a direct memory access (DMA) operation to the CUDA software stack (1) to access the data stored in the GPU buffer (0). In response, at step 450, the data engine (1) executes the DMA operation and copies the data from the GPU buffer (0) to the GPU buffer (1). After the data is copied to the GPU buffer (1), at step 455, the MPI library/engine (1) receives a notification from the CUDA software stack (1) that the DMA operation is complete.

In sum, the method steps may be repeated any number of times for any number of data transmission operations between one or more GPUs and/or GPU buffers on a computer system. These direct data transfers eliminates the need for a user (e.g., a programmer) to move data to system memory and/or another intermediate buffer before moving the data from an initial location to a desired location. The MPI libraries/engines are configured to carry out automatically such data transmission operations, thereby alleviating much of the work that had to be done by users/programmers in prior art approaches.

Embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the invention is set forth in the claims that follow.

1. A method for transmitting data between graphics processing unit (GPU) buffers, the method comprising:
receiving a handle from a send message passing interface (MPI) engine that resides in a first machine;
calling into a software stack with the handle, wherein the software stack resides in the first machine;
receiving an address of a send GPU buffer from the software stack, wherein the send GPU buffer resides in the first machine; and
issuing a command for a memory access operation to retrieve data from the send GPU buffer.

2. The method of claim 1, wherein the handle includes information for transmitting data from the send GPU buffer.

3. The method of claim 2, wherein the handle includes the address of the send GPU buffer.

4. The method of claim 2, further comprising issuing the command to the software stack to retrieve data from the send GPU buffer and then copy the data to a receive GPU buffer.

5. The method of claim 4, further comprising receiving a notification from the software stack that the memory access operation is complete.

6. The method of claim 5, further comprising registering the send GPU buffer with the software stack.

7. The method of claim 6, further comprising receiving the handle from the software stack in response to registering the send GPU buffer.

8. The method of claim 7, further comprising sending the handle from the send MPI engine to a receive MPI engine.

9. A non-transitory computer readable storage medium comprising instructions for transmitting data between graphics processing unit (GPU) buffers that, when executed by a message passing interface (MPI) engine, cause the MPI engine to carry out the steps of:
receiving a handle from a send message passing interface MPI engine that resides in a first machine;
calling into a software stack with the handle, wherein the software stack resides in the first machine;
receiving an address of a send GPU buffer from the software stack, wherein the send GPU buffer resides in the first machine; and
issuing a command for a memory access operation to retrieve data from the send GPU buffer.

10. The computer readable storage medium of claim 9, wherein the handle includes information for transmitting data from the send GPU buffer.

11. The computer readable storage medium of claim 10, wherein the handle includes the address of the send GPU buffer.

12. The computer readable storage medium of claim 10, further comprising issuing the command to the software stack to retrieve data from the send GPU buffer and then copy the data to a receive GPU buffer.

13. The computer readable storage medium of claim 12, further comprising receiving a notification from the software stack that the memory access operation is complete.

14. A system for transmitting data between graphics processing unit (GPU) buffers, the system comprising:
a receive GPU buffer that resides in a first machine; and
a receive message passing interface (MPI) engine that resides in the first machine, the receive MPI engine configured to perform the steps of:
receiving a handle from a send message passing interface (MPI) engine that resides in a first machine;
calling into a software stack with the handle, wherein the software stack resides in the first machine;
receiving an address of a send GPU buffer from the software stack,
wherein the send GPU buffer resides in the first machine; and
issuing a command for a memory access operation to retrieve data from the send GPU buffer.

15. The system of claim 14, wherein the handle includes information for transmitting data from the send GPU buffer.

16. The system of claim 15, wherein the handle includes the address of the send GPU buffer.

17. The system of claim 15, further comprising issuing the command to the software stack to retrieve data from the send GPU buffer and then copy the data to a receive GPU buffer.

18. The system of claim 17, further comprising receiving a notification from the software stack that the memory access operation is complete.

19. The system of claim 18, further comprising registering the send GPU buffer with the software stack.

20. The system of claim 19, further comprising receiving the handle from the software stack in response to registering the send GPU buffer.
